(19) United States
(12) Patent Application Publication
(10) Pub. No.: US 2008/0204443 A1
(43) Pub. Date: Aug. 28, 2008

(54) PORTABLE DISPLAY DEVICE AND DISPLAY METHOD OF PORTABLE DISPLAY DEVICE

(75) Inventors: Shigeo Morimoto, Hamura-shi (JP); Atsushi Nakamura, Hamura-shi (JP); Masao Iwasaki, Ome-shi (JP); Yasukazu Ohno, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/037,493

(22) Filed: Feb. 26, 2008

(30) Foreign Application Priority Data
Feb. 26, 2007 (JP) 2007-045896

(51) Int. Cl. G09G 5/00

(52) U.S. Cl. 345/211

(57) ABSTRACT

According to one embodiment, there is provided a portable display device including a recording section which records a video file, a decoder section which decodes the video file and outputs a video/audio signal, a display section which displays a video picture on a screen based on the video/audio signal from the decoder section, a backlight section which irradiates a back side of the display section, and a control section which determines the video file to be reproduced based on attribute information and turns off the irradiation of the backlight section based on a determined result.

### CROSS-REFERENCE TO RELATED APPLICATION

This application is based upon and claims the benefit of priority from Japanese Patent Application No. 2007-045896, filed Feb. 26, 2007, the entire contents of which are incorporated herein by reference.

### BACKGROUND

1. Field

One embodiment of the invention relates to a portable display device including a display section having a backlight section. The invention relates to the portable display device which turns off the backlight section at the time of reproducing a specified video file and a display method of the portable display device.

2. Description of the Related Art

As is publicly known, digital video technology is generalized very widely, and portable video display devices which display video files using the technology are being produced and being widely used. In such portable video display devices, since batteries or the like are used as power sources, techniques which save electricity of backlights in order to provide long use are known.

Patent Document 1 (Jpn. Pat. Appln. KOKAI Publication No. 2006-254185) discloses a technique which assumes that a user halts viewing on a video display device in the case where the user does not perform an operation for a certain time, for example, and turns off backlight so as to save electricity.

In the conventional technique in Patent Document 1, however, the following usage pattern is not taken into consideration. Namely, when a video file specialized in music such as recent video clips or music clips, for example, is reproduced, a mobile information terminal is put into a bag and only music is listened. That is to say, as to such a music-centered video file, only music is repeatedly listened without viewing video pictures in some occasions, and thus the backlight does not have to be ON for such a music-centered video file. Therefore, excess power consumption can be reduced by turning off the backlight, so that long-time reproduction is enabled. In the conventional technique in Patent Document 1, the power consumption of the backlight for a music-centered video file is not repressed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one example of a constitution of a portable display device according to one embodiment of the present invention;

FIG. 2 is an external view illustrating one example of an outline of the portable display device according to one embodiment of the present invention;

FIG. 3 is an external view illustrating another example of an outline of the portable display device according to one embodiment of the present invention;

FIG. 4 is a flow chart illustrating one example of a turning-off process of the backlight section in the portable display device according to one embodiment of the present invention;

FIG. 5 is an explanatory diagram illustrating one example of a setting screen for setting the turning-off process of the backlight section in the portable display device according to one embodiment of the present invention;

FIG. 6 is an explanatory diagram illustrating one example of a memory area for storing a video file being subject to the turning-off process of the backlight section in the portable display device according to one embodiment of the present invention;

FIG. 7 is an explanatory diagram illustrating one example of an off list for executing the turning-off process of the backlight section in the portable display device according to one embodiment of the present invention;

FIG. 8 is an explanatory diagram illustrating one example of genre information of the video file to be subject to the turning-off process of the backlight section in the portable display device according to one embodiment of the present invention;

FIG. 9 is an explanatory diagram illustrating one example of respective sensor conditions at the time of executing the turning-off process of the backlight section in the portable display device according to one embodiment of the present invention; and

FIG. 10 is an explanatory diagram illustrating another example of the respective sensor conditions at the time of executing the turning-off process of the backlight section in the portable display device according to one embodiment of the present invention.

### DETAILED DESCRIPTION

Various embodiments according to the invention will be described hereinafter with reference to the accompanying drawings. In general, according to one embodiment of the invention, there are provided a portable display device which turns off a backlight at the time of reproducing a specified video file and represses power consumption, and a display method of the portable display device.

One embodiment for achieving the above object is a portable display device comprising:

a recording section (15) which records a video file;

a decoder section (16) which decodes the video file and outputs a video/audio signal;

a display section (18) which displays a video picture on a screen based on the video/audio signal from the decoder section;

a backlight section (18-2) which irradiates a back side of the display section; and

a control section (13) which determines the video file to be reproduced based on attribute information and turns off the irradiation of the backlight section based on a determined result.

As a result, the backlight section is turned off for a music-centered video file or the like by specifying of a memory area, utilizing of a file list, detection of parameters and the like so that the power consumption can be repressed.

The embodiment of the present invention is described in detail below with reference to the drawings.

<Portable Display Device According to One Embodiment of the Present Invention>

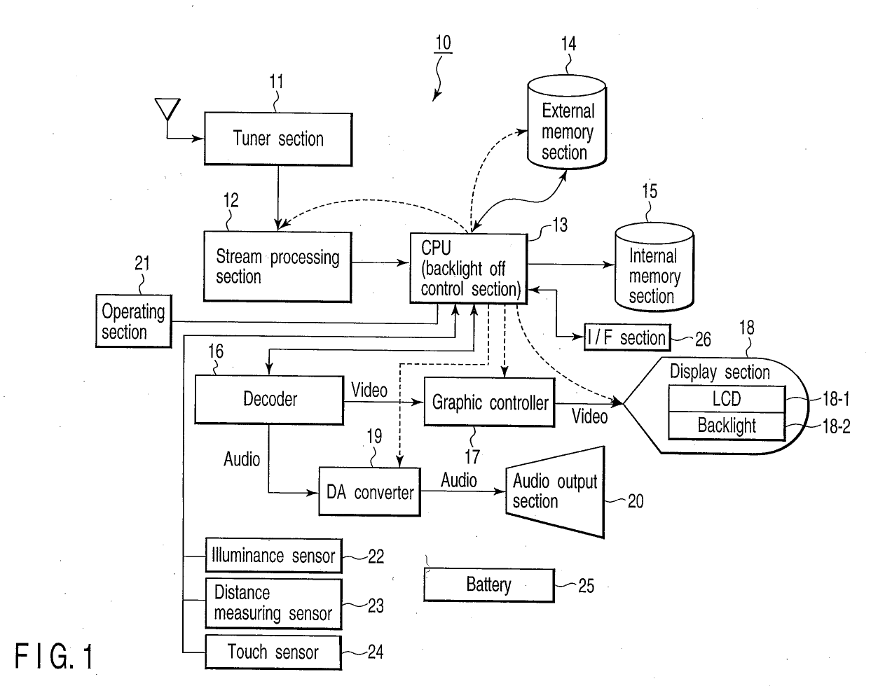

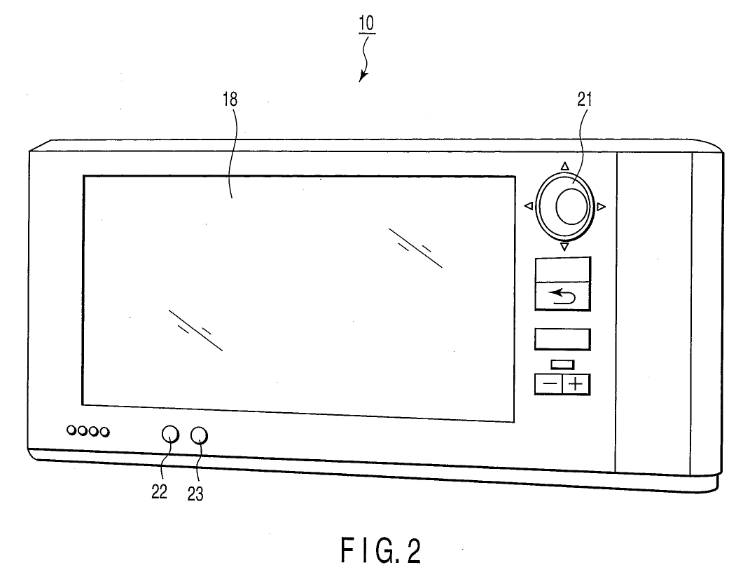

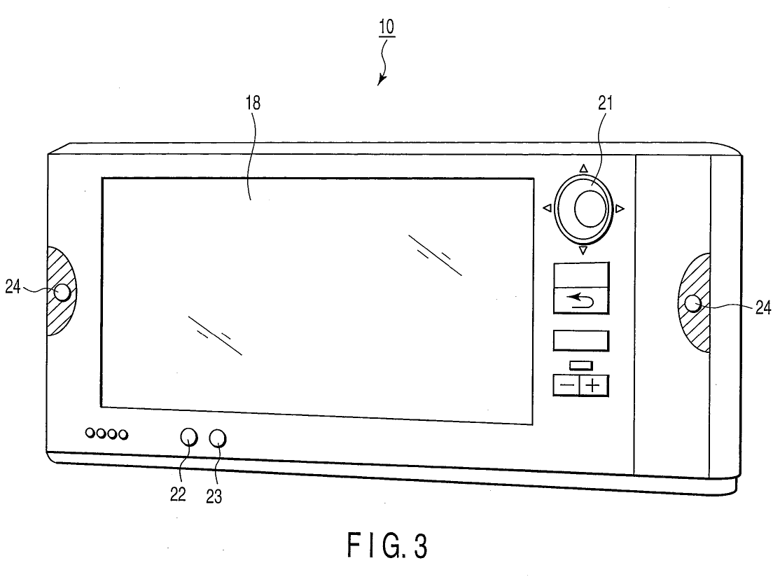

FIG. 1 is a block diagram illustrating one example of a constitution of a portable display device according to one embodiment of the present invention. FIGS. 2 and 3 are external views illustrating examples of outlines of the portable display device according to one embodiment of the present invention.

(Constitution)

One example of the portable display device according to one embodiment of the present invention is described in detail below with reference to FIG. 1. In FIG. 1, the portable display device according to one embodiment of the present invention has a CPU section 13, a tuner section 11, a stream processing section 12, a decoder section 16 such as an MPEG decoder, and a graphic controller section 17. The CPU section 13 is a control section which controls an entire operation. The tuner section 11 receives and demodulates a broadcast wave of terrestrial digital broadcasting or the like so as to output digital data as a stream of TS (Transport Stream) system, for example. The stream processing section 12 interprets stream data input from the tuner section 11 and eliminates unnecessary data or executes a PCR (Program Clock Reference) acquiring process by means of a programmable composite logic device. The decoder section 16 separates the stream data into audio data and video data so as to decode them. The graphic controller section 17 synthesizes video images or graphic data acquired in the decoder section 16 so as to output them to a display device.

Further, the portable display device 10 according to one embodiment of the present invention has an internal memory section 15 such as SDRAM (Synchronous Dynamic Random Access Memory), an external memory section 14 such as a detachable memory, and a DA converter 19 in FIG. 1. The internal memory section 15 is connected to the CPU section 13 as a control section via an interface or the like, and saves program data and video and audio data. The DA converter 19 DA-converts video/audio signals from the decoder section 16.

Further, in FIG. 1, the portable display device 10 has an audio output section 20, an LCD (Liquid Crystal Display) 18-1, a backlight section 18-2, an operating section 21 such as a power switching, a volume knob and a selection key, an illuminance sensor 22, a distance measuring sensor 23, a touch sensor 24, a battery section 25, and an I/F section 26 such as USB (Universal Serial Bus). The audio output section 20 outputs an audio signal to a speaker, a headphone or the like. The LCD 18-1 displays a video signal from the graphic controller section 17 on a screen. The backlight section 18-2 irradiates a back surface of the LCD 18-1. The illuminance sensor 22 detects brightness of a circumference and outputs a detected signal. The distance measuring sensor 23 outputs a detected signal according to a distance to an object. The touch sensor 24 detects user's touch and outputs a detected signal. The battery section 25 supplies a power source to the respective sections. In such a constitution, solid lines in FIG. 1 show a video signal, an audio signal and the like, and broken lines show a control signal and the like.

The illuminance sensor 22 and the distance measuring sensor 23 are provided below the LCD 18-1 or the like, for example as shown in FIG. 2. The touch sensor 24 is provided to an inner portion of a concave portion of the main body to be used by user for holding the main body of the portable display device 10 as shown in FIG. 3. In such a constitution, even if the main body of the portable display device 10 is put into a bag or the like, a detected signal is not output from the touch sensor 24, but a detected signal is output from the touch sensor 24 in a state that a user holds the main body in a hand.

(Basic Operation)

In the portable display device 10 according to one embodiment of the present invention having such a constitution, a stream signal is supplied from the tuner section 11 which receives terrestrial digital broadcasting to the stream processing section 12 or the like, for example, under the control of the CPU section 13. A packet signal or the like of MPEG according to the stream signal is decoded by the decoder section 16, and a video/audio signal according to the packet signal is supplied to the LCD 18-1 via the graphic controller section 17. As a result, a video picture according to the terrestrial digital broadcasting is displayed on the LCD 18-1. Similarly, the audio signal according to the terrestrial digital broadcasting is supplied to the speaker or the headphone via the DA converter 19, the audio output section 20 and the like.

A video file is supplied from an external PC or the like via the I/F section 26 such as the USB and is stored in the external memory section 14 such as a detachable memory, the internal memory section 15 or the like. Similarly, the video file is decoded by the decoder section 16 under the control of the CPU section 13, and is supplied to the LCD 18-1 via the graphic controller section 17. As a result, a video picture according to the video file is displayed on the LCD 18-1. Similarly, an audio signal according to the video file is supplied to the speaker or the headphone via the DA converter 19, the audio output section 20 and the like.

<One Example of the Turning-Off Process in the Backlight Section>

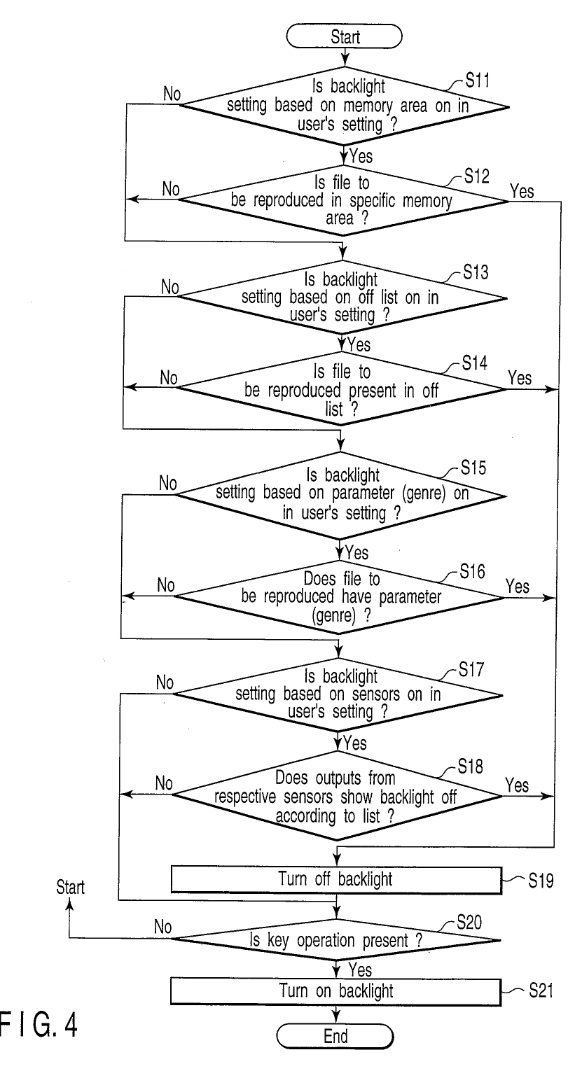

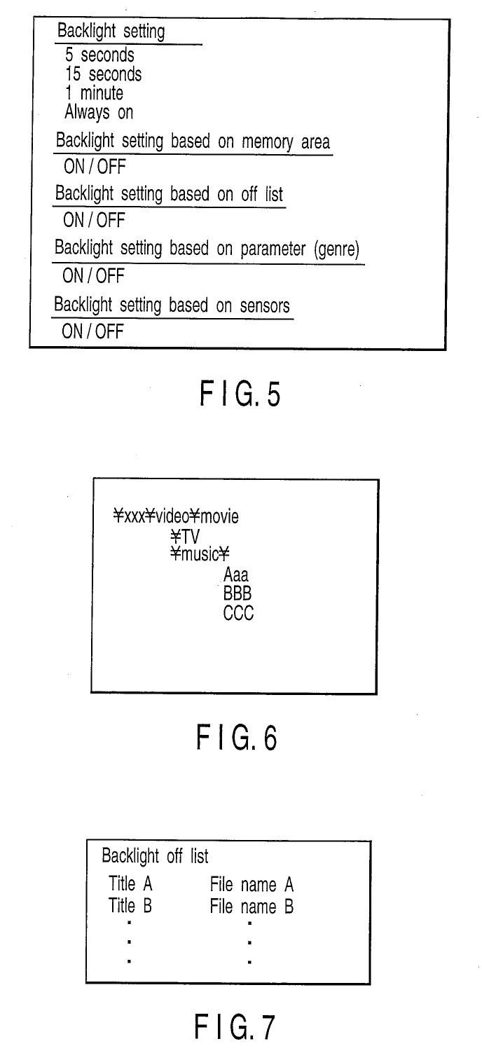

The portable display device according to one embodiment of the present invention which executes such a reproducing process turns off the backlight section as described in detail below with reference to the flowchart. As a result, for example, when a video file specific to music such as recent video clip or music clip is reproduced and a user puts a mobile information terminal into a bag so as to listen to only the sound, the backlight section is turned off so that power consumption can be efficiently repressed. FIG. 4 is a flowchart illustrating one example of the turning-off process of the backlight section in the portable display device according to one embodiment of the present invention. FIG. 5 is an explanatory diagram illustrating one example of a setting screen for setting the turning-off process of the backlight section in the portable display device according to one embodiment of the present invention.

The following respective steps in the flowchart of FIG. 4 can be replaced by circuit blocks, and thus all the steps in the flowchart of FIG. 4 can be defined as blocks.

In the portable display device according to one embodiment of the present invention, in the flowchart in FIG. 4, the time for which the back light is on is set on an initial setting screen shown in FIG. 5 via a user's operation on the operating section 21 under the control of the CPU section 13.

That is to say, the backlight is on during normal video reproduction. However, a determination is made whether the backlight should be on or off during reproduction of moving image. When the backlight may be turned off, the backlight is turned off even during the reproduction of the moving image. However, when a user performs the key operation, the backlight is turned on at the time of receiving the key operation because the screen cannot be seen with the backlight being off.

As to the time for which the backlight is on, as shown in FIG. 5, after the backlight is on for 5 seconds, 15 seconds or 1 minute according to the on time based on “backlight setting”, the backlight is turned off. In another manner, “always on” is selected. After the backlight is turned off, the key operation is always monitored during the reproduction of the moving image, and when the key operation is performed, the backlight is turned on.

In such backlight setting, simultaneously “on/off of the backlight setting based on the memory area”, “on/off of the backlight by means of off list”, “on/off of the backlight setting based on parameter (genre or the like)”, and “on/off of the backlight setting based on sensor” are set as the setting of the backlight off process according to one embodiment of the present invention. When “on” is selected in these settings, these menus are enabled, and when “off” is selected, these menus are disabled.

When the power of the portable display device 10 is turned on, the backlight is basically turned on. As shown in the flowchart of FIG. 4, however, in the setting state shown in FIG. 5, a backlight off control section of the CPU section 13 asks whether “the backlight setting based on the memory area” is ON (step S11).

When the answer is YES, the backlight off control section of the CPU section 13 specifies a predetermined area of the internal memory section 15 shown in FIG. 6, for example, a specific memory area such as “\xxx\video\movie\TV\music\”, and makes a determination whether three files stored in the memory area “Aaa, BBB, CCC” are video files to be produced currently (step S12). FIG. 6 is an explanatory diagram illustrating one example of the memory area for storing a video file to be subject to the turning-off process of the backlight section in the portable display device according to one embodiment of the present invention. “video\music” means a moving image mainly containing music such as a music clip, but any name can be given to a hierarchy, and thus “vide\BL_OFF” may be given.

When a video file to be reproduced is present in a specific memory area, the sequence goes to step S19, and the backlight section 18-2 is turned off by the operation of the backlight off control section of the CPU section 13 (step S19). As a result, the video picture on the LCD 18-1 cannot be practically viewed, but since an audio output is not changed, when a user listens to only sound, the power consumption of the battery section 25 can be effectively repressed.

At step S11, a determination is made whether the specifying of a specific memory area is set, and when a video file which is being reproduced is not present in the specific memory area even if the specifying is set, the sequence goes to step S13. The backlight off control section of the CPU section 13 determines whether “the backlight setting based on off list” is on the setting screen of FIG. 5 (step S13). FIG. 7 is an explanatory diagram illustrating one example of an off list for executing the turning-off process of the backlight section in the portable display device according to one embodiment of the present invention.

That is to say, in the case where a video file is recorded in a specific hierarchy so that the backlight control is made, the video file can be stored in a hierarchy for the backlight control only when the video file is transferred to the portable display device 10 or the portable display device 10 is connected to PC or the like to which the video file is supplied. For this reason, this case is inconvenient.

Therefore, a logical list such as “backlight off list” is created in a memory area of the internal memory section 15 or the CPU section 13, and a video file for turning off the backlight during the reproduction of a moving image is recorded in the list, so that the backlight control is suitably made as to a desired video file.

The backlight off control section of the CPU section 13 determines whether the setting is made by means of the off list (step S13). When the setting based on the off list is made, the backlight off control section determines whether a file having the file name shown in FIG. 7 is being reproduced (step S14). When the moving image file which is being reproduced is present, the sequence goes to step S19, and the backlight section 18-2 is turned off by the operation of the backlight off control section of the CPU section 13 (step S19). As a result, the power consumption of the battery section 25 can be repressed.

When the backlight off control section of the CPU section 13 determines that the setting based on the off list is not made, or that a video file which is being reproduced is not present in the off list even if the setting is made, the sequence goes to step S15.

The backlight off control section of the CPU section 13 determines whether “the backlight setting based on parameter (genre or the like)” is made (step S15). That is to say, the backlight is controlled by using information which can be owned by video contents.

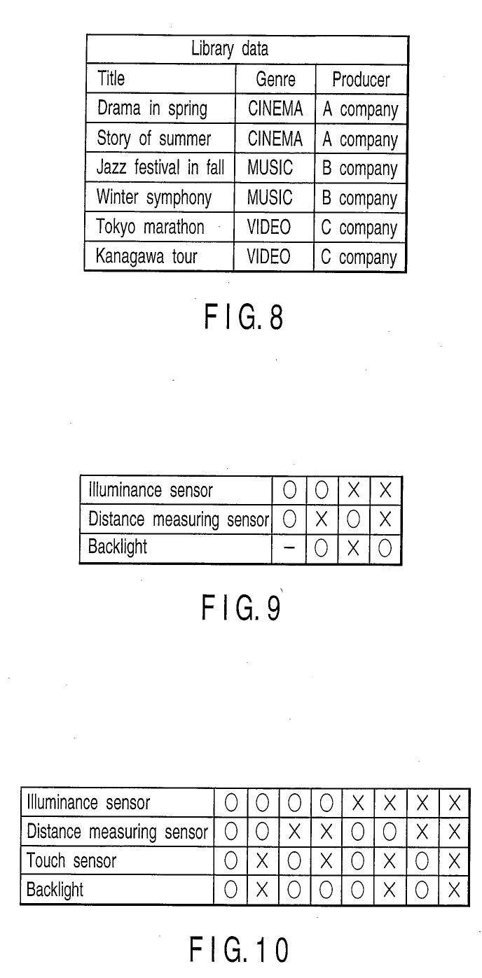

FIG. 8 is an explanatory diagram illustrating one example of genre information of a video file to be subject to the turning-off process of the backlight section in the portable display device according to one embodiment of the present invention. For example, “genre” can be set as information (tag information) in moving image contents such as WMV. “Music” or “Music Clip” is recorded in the “genre” information, so that the process for turning off the backlight can be executed by the “genre” information of the moving image contents at the time of reproducing the moving image.

When the backlight off control section of the CPU section 13 determines that “the backlight setting based on parameter (genre information and the like)” is on, it determines whether the parameters of the video file to be reproduced contain specific information (step S16). For example, the backlight off control section determines whether the “genre” information contains a specific word such as “music” or “Music Clip” as shown in FIG. 8.

When the backlight off control section of the CPU section 13 determines that such a specific parameter is present, the sequence goes to step S19, and the backlight section 18-2 is turned off by the operation of the backlight off control section of the CPU section 13 (step S19). As a result, the power consumption of the battery section 25 can be repressed.

When the backlight off control section of the CPU section 13 determines that a parameter is not set or when a specific parameter cannot be detected from the video file even if the parameter is set, the sequence goes to step S17. The backlight turning-off process is executed based on detected signals from a sensor group provided to the portable display device 10.

The backlight off control section of the CPU section 13 determines whether “the backlight setting based on sensors” is made (step S17). When the setting is made, for example as shown in FIGS. 9 and 10, the backlight off control section determines whether the backlight should be turned off based on the detected signals from the respective sensors. FIGS. 9 and 10 are explanatory diagrams illustrating examples of the conditions of the respective sensors to be subject to the turning-off process of the backlight section in the portable display device according to one embodiment of the present invention.

That is to say, in FIG. 9, as one example, the illuminance sensor 22 detects illuminance of not less than a certain value (◯) (circumference is bright), and the distance measuring sensor 23 does not detect an object near the portable display device 10 (x). In this case, it is estimated a normal user views a screen, and the determination is made that the backlight should be turned on.

In FIG. 9, the illuminance sensor 22 cannot detect illuminance of not less than certain value (x) (circumference is dark), and the distance measuring sensor 23 detects an object near the portable display device 10 (◯). In this case, it is estimated that the portable display device 10 is put into a bag and the user does not view the screen, and thus the determination is made that the backlight should be turned OFF.

In FIG. 10, as one example, the illuminance sensor 22 detects illuminance of not less than certain value (◯) (circumference is bright), the distance measuring sensor 23 detects an object near the portable display device 10 (◯), and the touch sensor is off (x) (possibility that the user does not hold the portable display device 10 is high). In this case, the circumference is bright but an obstacle is present near the portable display device 10, and it is estimated that a user does not try to view the portable display device 10 with it being held in user's hand. The determination is made that the backlight should be turned off (x).

In FIG. 10, as one example, the illuminance sensor 22 cannot detect illuminance of not less than certain value (x) (circumference is dark), the distance measuring sensor 23 does not detect an object near the portable display device 10 (x), and the touch sensor is on (◯) (possibility that the user holds the portable display device 10 is high). The circumference is dark at nigh, but an obstacle is not present near the portable display device 10, and it is estimated that the user tries to view the portable display device with it being held in user's hand. The determination is made that the backlight should be turned on (◯).

On a portion of “-” on the backlight, an obstacle is near the screen, but the circumference is bright. In this case, priority is suitably given to another backlight setting.

When the backlight off control section of the CPU section 13 determines that constant conditions shown in FIGS. 9 and 10 are satisfied according to the detected results in the respective sensors (step S18), the sequence goes to step S19 so that the backlight section 18-2 is turned off by the operation of the backlight off control section of the CPU section 13 (step S19). As a result, the power consumption of the battery section 25 can be repressed.

FIGS. 9 and 10 are examples of the embodiment, and suitably the setting can be freely made so that the backlight section is turned on or off according to combinations of the detected results. It is more suitable that the sensors other than the above ones are used, and all of them are included in the embodiment of the present invention.

After the backlight is turned off, the key operation is always monitored during the reproduction of moving image, and when the operating section 21 is operated, the backlight is turned on (step S21). As a result, the backlight section 18-2 is turned on by a user's operation on the portable display device 10, so that the video picture can be watched.

According to the above embodiment, a person skilled in the art can realize the present invention, and further easily arrives at various modified examples of the embodiment, and thus can apply the present invention to various embodiments without inventive ability. The present invention, therefore, covers a wide range where the invention is consistent with the disclosed principle and new feature, and thus is not limited to the above embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A portable display device comprising:
a recording section which records a video file;
a decoder section which decodes the video file and outputs a video/audio signal;
a display section which displays a video picture on a screen based on the video/audio signal from the decoder section;
a backlight section which irradiates a back side of the display section; and
a control section which determines the video file to be reproduced based on attribute information and turns off the irradiation of the backlight section based on a determined result.

2. The portable display device according to claim 1, wherein the control section operates the backlight section when a video picture is displayed on the screen based on a video file recorded in a first area of the recording section, and turns off the backlight section when a video picture is displayed on the screen based on a video file recorded in a second area different from the first area of the recording section.

3. The portable display device according to claim 1, wherein the control section turns off the backlight section when the video file to be reproduced is present in a previously provided list for turning off the backlight.

4. The portable display device according to claim 1, wherein the control section makes a determination based on genre information of a video file to be reproduced, and turns off the backlight section according to a determined result.

5. The portable display device according to claim 1, further comprising:
an illuminance sensor which is provided to a main body of the portable display device and outputs a detected signal according to a level of illuminance,
wherein the control section turns off the backlight section based on a detected signal from the illuminance sensor.

6. The portable display device according to claim 1, further comprising:
a distance measuring sensor which is provided to a main body of the portable display device and outputs a detected signal obtained by detecting a distance to an object to be detected,
wherein the control section turns off the backlight section based on the detected signal from the distance measuring sensor.

7. The portable display device according to claim 1, further comprising:
a touch sensor which is provided to a main body of the portable display device and outputs a detected signal obtained by detecting a contact with a sensor element,
wherein the control section turns off the backlight section based on the detected signal from the touch sensor.

8. The portable display device according to claim 1, further comprising:
an illuminance sensor which is provided to a main body of the portable display device and outputs a detected signal according to a level of illuminance;
a distance measuring sensor which is provided to the main body of the portable display device and outputs a detected signal obtained by detecting a distance to an object to be detected; and
a touch sensor which is provided to the main body of the portable display device and outputs a detected signal showing presence/non-presence of contact with a sensor section,
wherein the control section turns off the backlight section based on the detected signals from the illuminance sensor, the distance measuring sensor and the touch sensor.

9. The portable display device according to claim 1, wherein the control section turns off illumination of the backlight section based on at least one of a storage place of the memory section where the video file to be reproduced is stored, a determination whether the video file to be reproduced is present in a previously provided list for turning off the backlight, a determination based on genre information of the video file to be reproduced, and the detected signals from the sensors provided to the portable display device when setting is made so that the backlight section is turned off by a setting signal to be given.

10. A display method of a portable display device, comprising:
recording a video file in a memory area;
decoding the video file so as to output a video/audio signal; and
making a determination based on attribute information of the video file during output of the audio signal based on the video/audio signal so as to turn off a backlight section for irradiating a back side of a display section for displaying a video picture on a screen based on a determined result.
